(19) United States
(12) Patent Application Publication
(10) Pub. No.: US 2026/0095303 A1
(43) Pub. Date: Apr. 2, 2026

(54) CHIP FOR MULTIPLE HASH COMPUTATIONS BASED ON ROLLING AND UNROLLING

(71) Applicant: Soteria Inc., Seoul (KR)

(72) Inventors: Sinho YANG, Hwaseong-si (KR); SoonHong AHN, Hwaseong-si (KR); James Jongman KIM, Seongnam-si (KR)

(73) Assignee: Soteria Inc., Seoul (KR)

(21) Appl. No.: 19/341,665

(22) Filed: Sep. 26, 2025

(30) Foreign Application Priority Data
Oct. 2, 2024 (KR) 10-2024-0133544

(51) Int. Cl. H04L 9/06

(52) U.S. Cl. CPC H04L 9/0643

(57) ABSTRACT

The present invention relates to a chip for multiple hash computations based on rolling and unrolling, and more specifically, to a single chip for multiple hash computations in which multiple SHA-256 hash computations for finding hash values over a plurality of unrolled versions are simultaneously performed and the hash computations for each of the plurality of unrolled versions are repeatedly executed by rolling entire nonces, thereby reducing area and energy consumption of the chip while improving hash rate.

### CROSS REFERENCE TO RELATED APPLICATION

This application claims priority to Korea Patent Application No. 10-2024-0133544 filed on Oct. 2, 2024, the content of which is expressly incorporated by reference in its entirety.

### TECHNICAL FIELD

The present invention relates to a chip for multiple hash computations based on rolling and unrolling, and more specifically, to a single chip for multiple hash computations in which multiple SHA-256 hash computations for finding hash values over a plurality of unrolled versions are simultaneously performed and the hash computations for each of the plurality of unrolled versions are repeatedly executed by rolling entire nonces, thereby reducing area and energy consumption of the chip while improving hash rate.

### BACKGROUND

When designing a semiconductor chip, careful consideration must be given to performance, power consumption, area, heat generation, and reliability. The layout of the circuits is critical for satisfying these requirements and resolving associated issues.

Without optimization of the circuit layout in the chip design process, it is challenging to prevent issues including performance degradation, excessive power consumption, and manufacturing defects.

In semiconductor circuits, signals travel through wiring, so the longer the wiring, the greater the signal propagation delay, thereby leading to performance degradation. Therefore, by designing the circuit layout efficiently, wire length can be reduced, which in turn shortens signal transmission time. Additionally, an efficient layout allows the chip to operate at higher clock frequencies, and the higher the performance of a chip, the more operations it can perform per unit time.

In addition, wiring length and circuit density also have a significant influence on power consumption. The longer the wiring length, the more power it consumes, and excessive power consumption can lead to heating issues. If a high-power-consuming area and a low-power-consuming area are placed too closely together in a circuit, interference potentially causing malfunction may occur. Such issues should therefore be prevented through careful circuit layout design.

In addition, since the layout of circuits can significantly influence the overall chip area, reducing the chip area can lower production costs and increase yield during mass production.

In recently developed multi-core chips, heating issues have become a critical management concern. Circuits that generate significant heat must be evenly distributed across the chip to prevent performance degradation or damage caused by overheating.

Circuit layout design also plays a critical role in reducing defects that may occur during the manufacturing process. For example, if wires are placed too closely together, the likelihood of defects increases during fabrication. Therefore, proper layout not only helps minimize manufacturing errors but also facilitates easier testing and debugging, thereby enabling quicker identification and resolution of issues that may arise after production.

The requirements that must be considered when designing semiconductor chips should likewise be taken into account in hash computation chips.

The hash computation chip according to the present invention is provided as a highly optimized ASIC (Application-Specific Integrated Circuit) designed specifically for tasks such as cryptocurrency mining (e.g., Bitcoin). In other words, the requirements for the hash computation chip are to operate the hash algorithm very quickly, efficiently, and with low power consumption. Additionally, the chip should be small in size, free from damage or malfunction caused by heating, and guaranteed to be reliable.

Therefore, in the present invention, when processing the SHA-256 hash algorithm on a hash computation ASIC, an optimized layout that efficiently processes hash computations is derived to reduce power consumption and area while improving performance. To achieve this, SHA-256 hash algorithm is divided into multiple stages by considering operational processes related to expansion and compression, and an optimized arrangement of submodules for expansion and compression is developed for each stage.

Hereinafter, a brief description of prior art in the technical field of the present invention is provided, followed by a description of the technical aspects that the present invention aims to achieve in a differentiated manner compared to the prior art.

First, U.S. Pat. No. 11,947,889 B2 (Apr. 2, 2024) discloses a chip designed with a full-custom layout specifically for implementing cryptocurrency mining algorithms, particularly the SHA-256 algorithm.

The above-mentioned U.S. Pat. No. 11,947,889 B2 discloses that pipeline circuits of the expander and compressor are arranged by placing registers and combinational logic related to the expansions and round functions in separate areas, thus resulting in a structure different from the arrangement of the expander and compressor presented in the present invention.

In addition, Korean Patent No. 2,599,118 B1 (Nov. 1, 2023) focuses on optimizing the layout of circuit elements to reduce wasted space and improve efficiency. Specifically, if a particular routing space is vacant, it is identified and filled with other circuit elements, thereby eliminating the need to occupy a new standalone column and reducing the total number of columns in the cell placement.

The approach of Korean Patent No. 2,599,118 B1, which aims to improve the efficiency of chip area and energy by identifying empty spaces within multiple segmented routing regions and filling them with other circuit elements, significantly differs from the present invention, which focuses on version unrolling, nonce rolling, and optimizing the arrangement of expanders and compressors.

### BRIEF SUMMARY OF THE EMBODIMENTS

It is an objective of the present invention, devised to resolve the aforementioned issues, to provide a chip for multiple hash computations arranged to efficiently and simultaneously perform multiple SHA-256 hash computations.

It is another objective of the present invention to provide an ASIC for multiple hash computations that simultaneously performs multiple SHA-256 hash computations by unrolling multiple versions of the input message and rolling entire nonces for each unrolled version.

It is another objective of the present invention to process multiple SHA-256 hash computations at high speed while reducing power consumption and hardware area, by dividing the chip area into multiple stages in consideration of the processes of the expansion and compression, and deriving an optimized arrangement of expanders and compressors in each stage when arranging hardware for performing multiple SHA-256 hash computations.

It is characterized in that a chip for multiple hash computations according to an embodiment of the present invention comprises a plurality of clusters, each of the plurality of clusters comprising a first stage and a second stage, and the first stage and the second stage receive midstate values of version-unrolled hash computations as inputs and simultaneously perform multiple hash computations through nonce rolling.

It is characterized in that the chip for multiple hash computations further comprises a version unroller, wherein the version unroller unrolls a 32-bit version of a first 512-bit input message composed of the 32-bit version, a 256-bit previous hash block (values), and the first 224 bits of a 256-bit Merkle root, and outputs first 256-bit midstate values resulting from performing SHA-256 hash computations for each of the multiple unrolled versions.

It is characterized in that the version unroller further comprises a first pre-expander performing expansion on the first 512-bit input message for each of the multiple unrolled versions; and a first pre-compressor performing compression by applying the expanded message from the first pre-expander for each of the multiple unrolled versions and an initialization vector to round functions, and outputs each of the first midstate values as results of the hash computations for each of the multiple unrolled versions.

It is characterized in that the version unroller further comprises outputting second midstate values by applying the first four 32-bit message segments, which consist of the last 32 bits of the 256-bit Merkle root, a 32-bit timestamp, a 32-bit target value, and a 32-bit nonce from a second input message, which comprises the last 32 bits of the 256-bit Merkle root, a 32-bit timestamp, a 32-bit target value, a 32-bit nonce, a 1-bit indicator marking the end of the message, zero-padded bits, and a 32-bit message length, to round functions.

It is characterized in that the first stage comprises a first expander performing expansion starting from the 5th expansion of the second input message for each of the multiple unrolled versions, and a plurality of first compressors each performing compression by applying the expansion results from the first expander and the second midstate values to round functions for each of the multiple unrolled versions.

It is characterized in that the first stage comprises a first data receiver serially receiving data of the second midstate values for each of the multiple unrolled versions from the version unroller, wherein the first data receiver restores the received serial data by a 32-bit unit and provides the restored 32-bit data as input to the round functions of the plurality of first compressors.

It is characterized in that the first stage comprises a nonce roller outputting nonce-rolled second midstate values through a modification of the second midstate values by incrementing the nonce by 1 starting from the initial nonce, and repeatedly performs, through the plurality of first compressors, compressions by applying the expansion results from the first expander and the nonce-rolled second midstate values to round functions for each of the multiple unrolled versions.

It is characterized in that the first stage further comprises a second data receiver serially receiving data of the first midstate values for each of the multiple unrolled versions from the version unroller, wherein the second data receiver restores the received serial data by a 32-bit unit and adds the restored 32-bit data to hash computation results of final round function of the plurality of first compressors repeatedly rolled from the initial nonce, thereby generating third midstate values for each of the multiple unrolled versions.

It is characterized in that the first stage performs a pre-computation for the first round function by applying a 512-bit third input message and the 256-bit initialization vector to the round functions, and outputs fourth midstate values, wherein the 512-bit third input message includes the 256-bit third midstate values repeatedly rolled for each of the multiple unrolled versions and another 256-bit data including a 1-bit indicator representing that the 256-bit third midstate values are the last as message, zero-padded bits, and a 32-bit message length.

It is characterized in that the second stage comprises a second expander performing nonce-rolled expansion computations for the third input message for each of the multiple unrolled versions; and a second compressor performing compression computations by applying the message expanded from the second expander and the initialization vector to the round functions from the 1st round function to the 60th round function.

It is characterized in that the second stage further comprises a result transmitter outputting a final hash computation result by adding the nonce-rolled hash computation result from the round functions of the second compressor for each of the multiple unrolled versions to the initialization vector, a signal indicating the output of the final hash computation result, a signal indicating a result of deciding whether a block has been found through determining whether the final hash computation result is less than or equal to a target value, or a combination thereof.

It is characterized in that the first stage comprises a first expander and a plurality of first compressors, wherein at least one first compressor is placed both above and below the first expander and routed and wired such that the output of the first expander is shared among the at least one first compressor.

It is characterized in that the first stage and the second stage are horizontally placed for each of the multiple unrolled versions, such that the outputs of the first stage are routed to the inputs of the second stage, thereby minimizing the routed wiring length.

It is characterized in that in the second stage, at least one second expander and second compressor are placed adjacent to each other either horizontally or vertically, and the routed wiring lengths are minimized by routing the results of the second expander to the inputs of the second compressor.

It is characterized in that the version unroller is provided in the MCU, either inside or outside the chip for multiple hash computations, separately from the cluster, and the first pre-expander and the first pre-compressor are placed adjacent to each other horizontally for each of the multiple unrolled versions, such that the outputs of the first pre-expander are routed to the inputs of the first pre-compressor so as to minimize the routed wiring length.

It is characterized in that the chip for multiple hash computations comprises approximately 250 clusters (it may comprise fewer or more than 250), and each cluster performs double SHA-256 hash computations on 17 million nonces for at least four different multiple unrolled versions, respectively.

As described above, it is effective to enable the chip for multiple hash computations in accordance with the present invention to improve the hash rate by unrolling the versions of the input message into multiple different versions and performing multiple hash computations simultaneously.

In addition, it is effective to enable the chip for multiple hash computations in accordance with the present invention to find hash values intensively by configuring the chip to repeatedly execute multiple SHA-256 hash computations and find their hash values through nonce rolling for each unrolled version.

In addition, it is effective to enable the chip for multiple hash computations in accordance with the present invention to process multiple SHA-256 hash computations at high speed while reducing power consumption and hardware area, by configuring the chip for multiple hash computations with multiple clusters, configuring each cluster with multiple stages, enabling hash computation processors for multiple versions to be placed in parallel and operated simultaneously, and placing a single expander to be shared by multiple compressors in each version of the hash computation processor and routing wires between the single expander and the multiple compressors, or serially placing the expander and the compressor for each version and routing wires between the expander and the compressor.

### BRIEF DESCRIPTION OF THE DRAWINGS

FIG. 1 is a diagram illustrating a structure of the double SHA-256 hash computations used in the chip for multiple hash computations based on rolling and unrolling according to an embodiment of the present invention.

FIG. 2 is a diagram illustrating the structure of the chip for multiple hash computations based on rolling and unrolling according to an embodiment of the present invention.

FIG. 3 is a diagram illustrating the structure of a cluster in the chip for multiple hash computations based on rolling and unrolling according to an embodiment of the present invention.

FIG. 4 is a diagram illustrating the layout and data transmission and reception method of the chip for multiple hash computations based on rolling and unrolling according to an embodiment of the present invention.

FIG. 5 is a diagram illustrating the operational sequence of version unrolling and nonce rolling in the chip for multiple hash computations based on rolling and unrolling according to an embodiment of the present invention.

The Reference Numerals are described as follows: a chip for multiple hash computations as 100, an MCU as 200, a memory as 300, a cluster as 110, a control logic unit as 120, a version unroller as 1000, a first stage as 1100, a second stage as 1200, first pre-expanders as 1010, first pre-compressors as 1020, a first expander as 1110, first compressors as 1120a˜1120d, second expanders as 1210a˜1210d, second compressors as 1220a˜1220d, a first data (data1) receiver 1140, a second data (data2) receiver 1150, a nonce roller as 1130, a result (stage2 result) transmitter as 1230.

### DETAILED DESCRIPTION OF THE EXEMPLARY EMBODIMENTS

Hereinafter, preferred embodiments of the chip for multiple hash computations based on rolling and unrolling according to the present invention are described in detail with reference to the accompanying drawings. The same reference numerals presented in each drawing denote the same components. Additionally, the specific structural or functional descriptions for the embodiments of the present invention are merely illustrated for the purpose of explaining the embodiments according to the present invention. Unless otherwise defined, all terms used herein, including technical and scientific terms, shall have the same meaning as generally understood by those skilled in the art to which the present invention belongs. Terms defined in commonly used dictionaries should be interpreted to have meanings consistent with their contextual meanings in the related art, and unless explicitly defined otherwise in the specification, should not be interpreted in an idealized or overly formal sense.

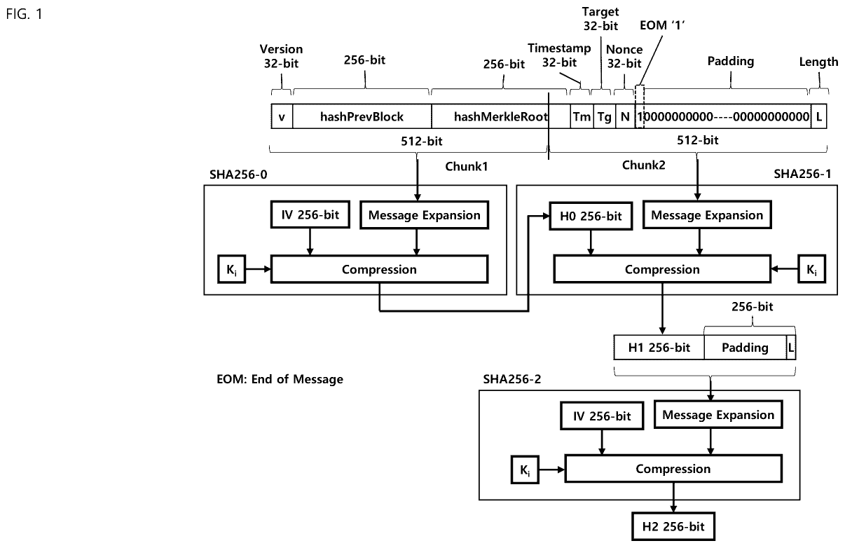

FIG. 1 is a diagram illustrating a structure of the double SHA-256 hash computations used in the chip for multiple hash computations based on rolling and unrolling according to an embodiment of the present invention.

As shown in FIG. 1, the process of performing the hash computation involves receiving an input message (i.e., an entire input message) and dividing the input message into 512-bit segments, namely a first 512-bit input message and a second 512-bit input message. If the total length of the input message exceeds 512 bits, the second 512-bit input message is formed from the excess bits of the entire input message. When the excess bits are not enough to form a full 512-bit of the second input message, zero (‘0’) bits are padded to complete the 512-bit segment.

Specifically, in the case of Bitcoin, the actual message content of the input message includes a 32-bit version, a 256-bit hash block derived from the previous hash computation (hashPrevBlock), a 256-bit Merkle root (hashMerkleRoot), a 32-bit timestamp, a 32-bit target value, and a 32-bit nonce. To use this actual message content for a hash computation, a bit of ‘1’ indicating the end of the message is appended at the end of the message content. Additionally, in the last 32 bits of the 512-bit input message, the message length (e.g., 0x00000280=640 bits) is added. Zero (‘0’) bits are padded between the appended bit ‘1’ indicating the end of the message (EOM) and the message length.

As illustrated above, once two 512-bit input messages are prepared, the first 512-bit input message is processed in SHA256-0 for a message expansion, in which the sixteen 32-bit input words are expanded and scheduled into sixty-four 32-bit words. The message expansion is equivalent to a message scheduling; therefore, an expander is also referred to as a scheduler.

Subsequently, the expanded message is compressed in a compressor together with predefined input constants (Kᵢ) and a 256-bit initialization vector (IV), and the compressor outputs a 256-bit hash digest (H0) as the result of the hash computation.

The resulting 256-bit hash digest (H0) is then applied as an input to a second SHA-256 operation (SHA256-1), in which the hash digest H0 and the input constants Kᵢ, together with the message expanded or scheduled from the second 512-bit input message (composed of sixteen 32-bit words) into sixty-four 32-bit words, are fed into the compression of the SHA256-1.

The result of the compression is a 256-bit hash value (hash digest) (H1), which then serves as the input message for the third SHA-256 hash computation (SHA256-2). Since the hash value H1 itself constitutes the input message of the SHA256-2, a bit ‘1’ is appended to H1, and a 32-bit message length is appended at the end of the input message. In this case, the message length is 0x00000100 (=256).

The third hash computation, SHA256-2, expands or schedules the 256-bit initialization vector (IV), input constants (Kᵢ), and the input message into 64 32-bit words, compresses the expanded or scheduled words, and outputs the final hash value H2.

If the resulting hash value H2 is less than or equal to the target value, it indicates that a new block has been successfully found. Each of the hash computations (SHA256-0, SHA256-1, and SHA256-2) includes dedicated operation blocks for performing message expansion and compression for the round functions.

As described above, the double SHA-256 operations performed in the present invention are structured to execute multiple hash computations and output the final hash value.

The multiple hash computations, as described above, first perform SHA256-0 on a first 512-bit input message (also referred to as chunk1) to output a 256-bit hash value (H0). The first 512-bit input message consists of a 256-bit initialization vector (IV), a 32-bit version, a 256-bit previous hash block (i.e., value), and the first 224 bits of the 256-bit Merkle root.

Next, SHA256-1 is performed on a second 512-bit input message (also referred to as chunk2) to produce a hash value (H1). The second 512-bit input message includes the 256-bit hash value (H0) resulting from the SHA256-0 operation, the last 32 bits of the 256-bit Merkle root, a 32-bit timestamp, a 32-bit target value, a 32-bit nonce, a 1-bit indicator representing the end of the input message, zero-padding bits, and a 32-bit message length.

Subsequently, SHA256-2 is performed on a third 512-bit input message to produce a final hash value H2. The third 512-bit input message is composed of the 256-bit initialization vector (IV), the 256-bit hash value (H1) produced by SHA256-1, a 1-bit indicator representing the end of the message immediately followed by H1, zero-padding bits, and a 32-bit message length.

Meanwhile, the message expansion performed on the first 512-bit input message in the expander involves directly inputting the first 16 32-bit words into the initial 16 round functions for the compression in the compressor. Thereafter, the first 512-bit input message is expanded into an additional 48 32-bit words according to [Equation 1] for calculating Wᵢ, and the expanded 48 input words are fed into the subsequent 48 round functions of the compressor.

$${W}_{i} = {M}_{i} , 0 \leq i \leq 15 , \qquad [ Equation 1 ]$$

$${W}_{i} = {σ}_{1} ( {W}_{i - 2} ) + {W}_{i - 7} + {σ}_{0} ( {W}_{i - 15} ) + {W}_{i - 16} , 16 \leq i \leq 63 .$$

Here, σ₀(x) is defined as ROTR7(x) XOR ROTR18(x) XOR SHR3(x), and σ₁(x) is defined as ROTR17(x) XOR ROTR19(x) XOR SHR10(x). ROTR7 is a right rotation by 7 bits, in which the higher-order bits are shifted toward the lower-order bits one by one, and the least significant bit (LSB) is wrapped around to fill the most significant bit (MSB). SHR3 denotes an operation that shifts the bits of x to the right by 3 positions, filling the leftmost bits with zeros. The XOR operation represents a bitwise exclusive OR.

Moreover, the compression performed by the compressor is expressed by [Equation 2], which represents the round functions executed over 64 rounds, from step 0 to step 63.

$${h}_{i + 1} = {g}_{i} ; {g}_{i + 1} = {f}_{i} ; {f}_{1 + 1} = {e}_{i} ; \qquad [ Equation 2 ]$$

$${e}_{i + 1} = {d}_{i} + {h}_{i} + {\sum }_{1} ( {e}_{i} ) + Ch ( {e}_{i} , {f}_{i} , {g}_{i} ) + {K}_{i} + {W}_{i} ;$$

$${d}_{i + 1} = {c}_{i} ; {c}_{i + 1} = {b}_{i} ; {b}_{i + 1} = {a}_{i} ;$$

$${a}_{i + 1} = {h}_{i} + {\sum }_{1} ( {e}_{i} ) + Ch ( {e}_{i} , {f}_{i} , {g}_{i} ) + {\sum }_{0} ( {a}_{i} ) + Maj ( {a}_{i} , {b}_{i} , {c}_{i} ) + {K}_{i} + {W}_{i} .$$

Here, Ch(x, y, z)=(x AND y) XOR (NOT(x) AND z), Maj(x, y, z)=(x AND y) XOR(x AND z) XOR (y AND z), Σ₀(x)=ROTR2(x) XOR ROTR13(x) XOR ROTR22(x), Σ1(x)=ROTR6(x) XOR ROTR11(x) XOR ROTR25(x).

Hereinafter, the structure of the chip for multiple hash computations based on rolling and unrolling, as applied to the hash computation algorithm described above for Bitcoin mining according to an embodiment of the present invention, is described in detail.

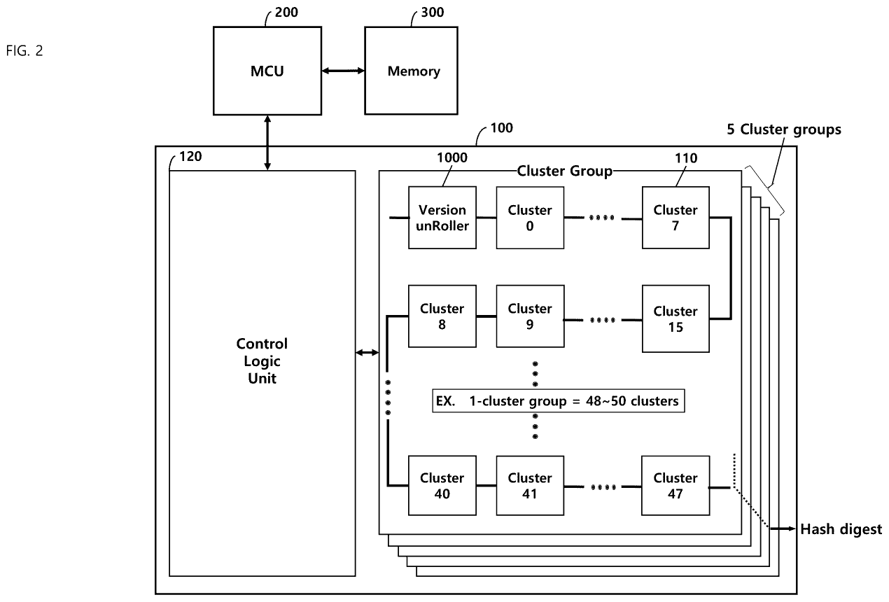

FIG. 2 is a diagram illustrating the structure of the chip for multiple hash computations based on rolling and unrolling according to an embodiment of the present invention.

As shown in FIG. 2, the chip for multiple hash computations 100 based on rolling and unrolling according to an embodiment of the present invention includes a cluster group composed of one or more clusters 110, and control logic unit 120.

In addition, the chip for multiple hash computations 100 may further include a version unroller 1000, which may be implemented separately from the cluster 110 in a microcontroller unit (MCU) 200 located either inside or outside the chip for multiple hash computations 100.

Although five cluster groups are illustrated in FIG. 2, the actual number of cluster groups is not limited to any specific upper or lower bound. Furthermore, the cluster groups may be arranged on different planes or layers of the chip, or alternatively, may be disposed on the same plane or layer.

In addition, the chip for multiple hash computations 100 based on rolling and unrolling according to an embodiment of the present invention is configured to exchange data or commands with an MCU 200. The MCU 200 may store data in a memory 300, perform portions of the hash computations in advance by loading data from the memory, or store the results of the hash computations in the memory 300. The MCU 200 may also provide input messages to the chip for multiple hash computations 100 or control the operations of the chip for multiple hash computations 100.

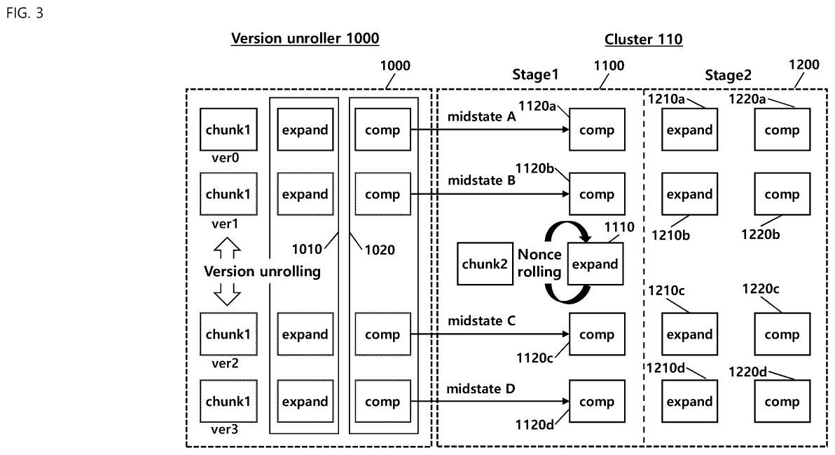

The number of clusters 110 in a cluster group may be configured to range from 48 to 50, and each cluster is configured to perform double SHA-256 computations unrolled for a plurality of versions. A detailed description of each cluster is provided later with reference to FIG. 3, and therefore, a detailed explanation is omitted herein.

The chip for multiple hash computations 100 based on rolling and unrolling according to an embodiment of the present invention is configured to include a number of clusters sufficient to perform repeated computations by rolling the nonce over the range from 0 to 0xFFFFFFFF for the plurality of unrolled versions.

In the present invention, for example, the chip for multiple hash computations 100 is configured to simultaneously process four unrolled versions. The overall scale of the chip is determined such that 232 (i.e., approximately 4.29 billion) nonces for each unrolled version are rolled and hash computations of the rolled nonces are repeatedly performed. Under this consideration, the chip for multiple hash computations 100 is configured to include five cluster groups, each comprising approximately 50 clusters. That is, each cluster group may include, for example, 48 clusters (fewer than 50) or 51 clusters (more than 50).

Accordingly, approximately 250 clusters are required for the chip. However, it is not necessary to include exactly 250 clusters, and the number of clusters may be less than or greater than 250. In addition, it is not essential to utilize all 250 clusters. For example, if 250 clusters are included, each cluster only needs to perform approximately 17,160,000 nonce rollings. That is, each cluster is required to repeatedly perform about 17 million nonce rollings.

For example, if the total number of clusters is 249, the number of nonces allocated per a cluster is determined by dividing the total number of nonces by the number of clusters, resulting in approximately 0x01073260 (i.e., 17 million) nonces per a cluster.

Accordingly, the nonce values can be set respectively as 0x00000000 to 0x0107325F, 0x01073260 to 0x020E64BF, 0x020E64C0 to 0x0315971F, . . . , and 0xFEF8CD00 to 0xFFFFFFFF. This means that, when rolling the nonce during the hash computations, each nonce can be treated as a constant, thereby allowing certain hash computations to be simplified.

Each cluster may be configured to iterate the nonces starting from a nonce start position for an assigned period (=0x01073260 (=approximately 17 million nonces). Since the nonce start position is a fixed value, this value can be hardwired from the beginning when designing the hardware.

Furthermore, the data, including input messages or midstate values, delivered between the control logic unit 120, the external/internal MCU 200, or adjacent clusters 110 can be relayed serially. Serially relaying data between clusters reduces the data bus width and allows the data transmission to be synchronized with the internal local clock, thereby enabling data transmission operations at speeds significantly higher than those of conventional serial communication protocols.

While data transmission between clusters can be unidirectional, it is also configured to enable bidirectional communication with acknowledgment of data receipt.

The numbers of cluster groups and clusters described above embodiments are provided only as examples and can be configured and operated in various ways according to requirements.

While the control logic unit 120 includes a test manager, a task manager, a clock controller, a UART (Universal Asynchronous Receiver and Transmitter), a bad core manager, and the like, detailed descriptions of these components are omitted.

The clock controller is responsible for supplying a clock to each cluster group. If a fault occurs in a specific cluster, the clock supply to the corresponding cluster is stopped to prevent the faulty cluster from further operation. Additionally, even if a particular cluster ceases operation, the adjacent clusters can continue computations independently without interruption by directly bypassing the input data of the faulty cluster to its output data.

The UART, as a type of serial communication protocol, is used solely for communication between the chip for multiple hash computations 100 based on rolling and unrolling according to the present invention and the external MCU 200.

When the number of clusters 110 included in a cluster group is large, additional separate clock lines should be provided for each cluster. In this case, the excessive number of clock lines increases wiring area and complexity, which may also lead to higher power consumption due to the complicated clock network. Therefore, it is preferable to configure a clock tree that ensures normal clock supply through the main clock line while branching clock lines to each cluster. If a fault occurs in a cluster, it is preferable to configure the branched clock line to the faulty cluster so that it can be individually disabled.

Hereinafter, the internal structure of each cluster is described.

FIG. 3 is a diagram illustrating the structure of a cluster in the chip for multiple hash computations based on rolling and unrolling according to an embodiment of the present invention.

As shown in FIG. 3, the chip for multiple hash computations 100 based on rolling and unrolling according to the present invention comprises a plurality of clusters 110. Each of the clusters 110 includes a first stage 1100 and a second stage 1200. The first stage 1100 and the second stage 1200 receive midstate values of version-unrolled hash computations as inputs and simultaneously perform multiple hash computations through nonce rolling.

The chip for multiple hash computations 100 further includes a version unroller 1000, which is provided in MCU 200, either inside or outside the chip for multiple hash computations 100, separately from the cluster 110.

The version unroller 1000 is configured to unroll a version of a first 512-bit input message (i.e., chunk1), which is composed of a 32-bit version, a 256-bit previous hash block, and a first 224 bits of a 256-bit Merkle root, and to output a first 256-bit midstate value resulting from performing SHA-256 hash computations for each of the multiple unrolled versions.

The version unroller 1000 further comprises first pre-expanders 1010, which perform expansions on the first 512-bit input message for each of the multiple unrolled versions and first pre-compressors 1020, which perform compressions by applying the expanded messages from the first pre-expanders together with the initialization vector (IV) to round functions, and output each of first midstate values as a result of the hash computations for the multiple unrolled versions.

The version unroller 1000 is configured to output second midstate values by applying first four 32-bit message words of the second input message (i.e., chunk2) to round functions. The first four 32-bit message words consist of last 32-bit of the 256-bit Merkle root, a 32-bit timestamp, a 32-bit target value, and a 32-bit nonce (starting position), and the second input message (i.e., chunk2) comprises the last 32-bit of the 256-bit Merkle root, a 32-bit timestamp, a 32-bit target value, a 32-bit nonce, a 1-bit indicator marking the end of the message, zero-padded bits, and a 32-bit message length. Nonce rolling refers to repeatedly performing hash computations by starting from the initial nonce and incrementing the nonce by one each time. This mechanism is described in more detail in the nonce roller.

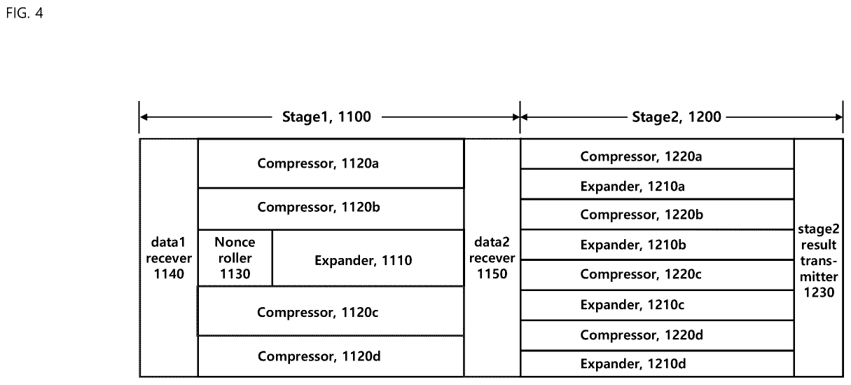

The depicted midstates A, B, C, and D may each represent either a first midstate or a second midstate. Further details regarding the first and second midstate values are provided in the description of FIG. 4.

The version unroller 1000 is also configured such that, for each version, the first pre-expander 1010 and the first pre-compressor 1020 are placed horizontally adjacent to each other. This layout allows the outputs of the first pre-expanders 1010 to be routed directly to the inputs of the first pre-compressors 1020, thereby minimizing wire routing length.

Meanwhile, the first stage 1100 comprises, for each of the multiple unrolled versions, a first expander 1110 configured to perform expansion on the second input message (chunk2) starting from the fifth word, and a plurality of first compressors 1120a, 1120b, 1120c, 1120d, which are configured to perform compressions by applying the results of the expansion from the first expander 1110 and the second midstate values to round functions.

The first stage 1100 also comprises the first expander 1110 and a plurality of first compressors 1120a, 1120b, 1120c, and 1120d. The first expander 1110 is configured such that at least one of the first compressors 1120a, 1120b, 1120c, and 1120d is placed above and below the first expander, respectively. The output of the first expander 1110 is routed and wired in a manner that allows the output to be shared among the multiple first compressors 1120a, 1120b, 1120c, and 1120d.

The first stage 1100 and the second stage 1200 are placed horizontally for each of the multiple unrolled versions, allowing the output of the first stage 1100 to be routed and wired as the input to the second stage 1200, thereby minimizing wire routing length.

The second stage 1200 is configured such that, for each of the multiple unrolled versions, a plurality of second expanders 1210a, 1210b, 1210c, and 1210d are configured to perform nonce-rolled expansions on the third input message, and a plurality of second compressors 1220a, 1220b, 1220c, and 1220d are configured to perform compressions by applying the input messages expanded by the second expanders 1210a, 1210b, 1210c, and 1210d together with the initialization vector (IV) to the round functions from the first round to the 60th round.

The second stage 1200 is configured such that at least one of the second expanders 1210a, 1210b, 1210c, and 1210d and the second compressors 1220a, 1220b, 1220c, and 1220d are placed adjacent to each other, either horizontally or vertically. This placement allows the outputs of the second expanders 1210a, 1210b, 1210c, and 1210d to be routed directly as inputs to the second compressors 1220a, 1220b, 1220c, and 1220d, thereby minimizing wire routing length.

The hash computation results of the second stage 1200 are obtained by performing double SHA-256 hash computations on each of the multiple unrolled versions.

FIG. 4 is a diagram illustrating the layout and data transmission and reception method of the chip for multiple hash computations based on rolling and unrolling according to an embodiment of the present invention.

As shown in FIG. 4, in the chip for multiple hash computations 100 according to an embodiment of the present invention, the first stage 1100 includes a first data (data1) receiver 1140, which is configured to serially receive data of the second midstate values for each of the multiple unrolled versions from the version unroller.

The first data receiver 1140 is configured to restore the received serial data into 32-bit words and provide the restored data to the round functions of the first compressors 1120a, 1120b, 1120c, and 1120d.

The first stage 1100 is further configured to include a nonce roller 1130, which outputs nonce-rolled second midstate values by modifying the second input messages through incrementing the nonce by 1, starting from the initial nonce (i.e., starting position of nonce).

The nonce roller 1130 is configured to repeatedly perform compressions by applying, through the first compressors 1120a, 1120b, 1120c, and 1120d, the results of the expansion from the first expander 1110 and the nonce-rolled second midstate value to the round functions for each of the multiple unrolled versions.

Additionally, the first stage 1100 is further configured to include a second data (data2) receiver 1150, which serially receives data of the first midstate values for each of the multiple unrolled versions from the version unroller.

The second data receiver 1150 is configured to restore the received serial data into data of 32-bit words and calculate third midstate values by adding the restored data to the hash computation results of final round function of the first compressors 1120a, 1120b, 1120c, and 1120d, which are repeatedly rolled starting from the initial nonce (i.e., starting position of the nonce) for each of the multiple unrolled versions.

The first stage 1100 may further be configured to perform a pre-computation for the first round function by apply a 512-bit third input message and the initialization vector to the first round function. The 512-bit third input message consists of 256-bit third midstate values that are nonce-rolled for each of the multiple unrolled versions, and another 256 bits including a 1-bit indicator marking that the third midstate values are the last input message, zero-padded bits, and a 32-bit field indicating the length of the third input message.

The computation for the first round function of SHA256-2 can be pre-calculated before starting the computation of SHA256-2, based on the computation results of the SHA256-1 and predetermined constants.

The second stage 1200 is further configured to include a result (stage2 result) transmitter that outputs a final hash computation result by adding the nonce-rolled hash computation results from the round functions of the second compressors 1220a, 1220b, 1220c, and 1220d for each of the multiple unrolled versions to the initialization vector (IV), a signal indicating the output of the final hash computation result, a signal indicating the result of determining whether a block has been found by checking if the final hash computation result is less than or equal to the target value, or a combination thereof.

In the second stage 1200, 60 round functions from round 1 to round 60 of the SHA256-2 hash computation are executed. It is possible to determine in advance whether a valid block has been found by monitoring the value of e for the previous three rounds of h. In SHA256-2, the output hash value is arranged in the order of h, g, f, c, d, c, b, and a, forming a 256-bit sequence. If the value of h in the final hash values does not satisfy the Bitcoin target value difficulty condition (i.e., being at least zero), it is determined that no valid hash block has been found, and it is configured to exit without executing round 61 to 63. If the value of e for the previous three rounds of h is zero, the remaining three rounds (round 61 to 63) are executed, and if the resulting hash value is less than or equal to the target value, a new valid hash block is considered to have been found.

In this context, the hash value h was previously g, g was f, and f was originally e. Thus, if the value of e in three rounds prior to the final round (round 63), is not zero, it is determined in advance that a valid hash block has not been found, and the subsequent rounds are not executed but terminated, thereby reducing power consumption. For reference, the first round of SHA256-2 is configured to perform the computation by adding the input hash values and the hash results together at the end of the first stage.

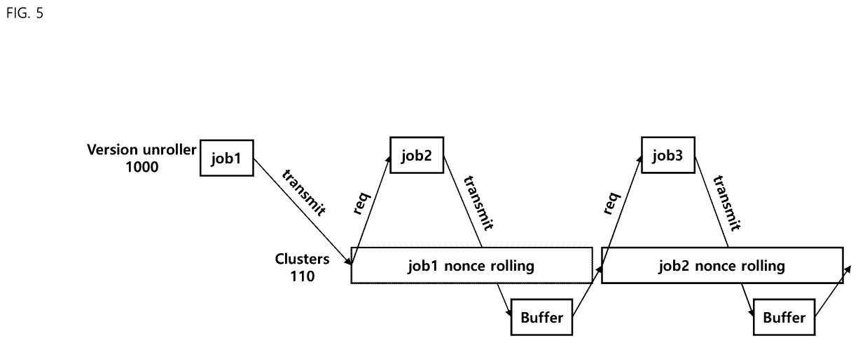

FIG. 5 is a diagram illustrating the operational sequence of version unrolling and nonce rolling in the chip for multiple hash computations based on rolling and unrolling according to an embodiment of the present invention.

As shown in FIG. 5, the version unroller 1000, according to an embodiment of the present invention, transmits certain portions of hash computation results to cluster 110. These portions include from the first midstates obtained by executing multiple SHA256-0 computations on multiple unrolled versions of the input message to the second midstates obtained by executing hash computations on the initial 4 rounds of SHA256-1. The task performed by the version unroller 1000 is referred to as job1.

The cluster 110 performs hash computations by rolling the 232 nonces for each of the second midstates unrolled from the version unroller 1000. The task performed by the cluster 110 corresponds to job1 nonce rolling.

While performing job1 nonce rolling, the version unroller 1000 unrolls a new set of multiple versions, performs job2 in the same manner as job1, and stores the results in a buffer.

Since there is significantly much more time margin for performing hash computation through version unrolling compared to performing hash computations over the entire nonce through nonce rolling, the results of the version unrolling are stored in a buffer and held until the completion of job1 nonce rolling.

The version unrolling for job3 and job2 nonce rolling is performed in the same sequence as the version unrolling for job2 and job1 nonce rolling.

As described above, it is effective to enable the chip for multiple hash computations 100 in accordance with the present invention, to improve the hash rate by unrolling the versions of the input message into multiple different versions and performing multiple hash computations simultaneously.

In addition, it is effective to enable the chip for multiple hash computations 100 in accordance with the present invention, to find hash values intensively by configuring the chip to repeatedly execute multiple SHA-256 hash computations to find their hash values through nonce rolling for each unrolled version.

In addition, it is effective to enable the chip for multiple hash computations 100 in accordance with the present invention, to process multiple SHA-256 hash computations at high speed while reducing power consumption and hardware area, by configuring the chip for multiple hash computations 100 with multiple clusters, configuring each cluster with multiple stages, enabling hash computation processors for multiple versions to be placed in parallel and operated simultaneously, and placing a single expander to be shared by multiple compressors in each version of the hash computation processors and routing wires between the single expander and the multiple compressors or serially placing the expander and the compressor for each version and routing wires between the expander and the compressor.

At least one of the components, elements, modules or units (collectively “components” in this paragraph) represented by a block or an equivalent indication in the drawings including FIG. 2 may be implemented or embodied by analog and/or digital circuits including one or more of a logic gate, an integrated circuit, a microprocessor, a microcontroller, a memory circuit, a passive electronic component, an active electronic component, an optical component, and the like. Alternatively or additionally, these components may be implemented or embodied by software including one or more instructions stored in an internal or external storage medium that is readable by at least one processor. For example, the at least one processor may invoke at least one of the one or more instructions stored in the storage medium, and execute it, with or without using one or more other components under the control of the at least one processor. This allows the at least one processor to perform at least one function or operation described above as being performed by each of the components according to the at least one instruction invoked. Here, the at least one processor may include a central processing unit (CPU), a graphic processing unit (GPU), another type of microprocessor, not being limited thereto.

While the present invention has been described with reference to the embodiments illustrated in the drawings, it is to be understood that these embodiments are exemplary and not limiting. Those skilled in the art will appreciate that various modifications and equivalent alternative embodiments are possible based on the disclosure herein. Therefore, the technical scope of the present invention should be determined by the claims set forth below.

What is claimed is:

1. A chip for multiple hash computations based on nonce rolling and version unrolling, comprising:
a plurality of clusters, each comprising:
a first stage; and
a second stage,
wherein the first stage and the second stage receive midstate values of version-unrolled hash computations as inputs and simultaneously perform multiple hash computations through nonce rolling.

2. The chip of claim 1, further comprising:
a version unroller,
wherein the version unroller unrolls a 32-bit version of a first 512-bit input message composed of the 32-bit version, a 256-bit previous hash block, and a first 224 bits of a 256-bit Merkle root, and outputs a first 256-bit midstate values resulting from performing SHA-256 hash computations for each of the multiple unrolled versions.

3. The chip of claim 2, wherein the version unroller comprises:
a first pre-expander performing expansion on the first 512-bit input message for each of the multiple unrolled versions; and
a first pre-compressor performing compression by applying the expanded message from the first pre-expander for each of the multiple unrolled versions and an initialization vector to round functions, and outputs each of first midstate values as results of the hash computations for each of the multiple unrolled versions.

4. The chip of claim 3, wherein the version unroller outputs second midstate values by applying first four 32-bit message segments which consist of last 32-bit of the 256-bit Merkle root, a 32-bit timestamp, a 32-bit target value, and a 32-bit nonce from a second input message which comprises last 32-bit of the 256-bit Merkle root, a 32-bit timestamp, a 32-bit target value, a 32-bit nonce, a 1-bit indicator marking the end of the message, zero-padded bits, and a 32-bit message length to round functions.

5. The chip of claim 4, wherein the first stage comprises:
a first expander performing expansion starting from the 5th expansion of the second input message for each of the multiple unrolled versions; and
a plurality of first compressors each performing compression by applying the expansion results from the first expander and the second midstate values to round functions for each of the multiple unrolled versions.

6. The chip of claim 5, wherein the first stage further comprises:
a first data receiver serially receiving data of the second midstate values for each of the multiple unrolled versions from the version unroller,
wherein the first data receiver restores the received serial data by a 32-bit unit and provides the restored 32-bit data as inputs to the round functions of the plurality of first compressors.

7. The chip of claim 6, wherein the first stage further comprises:
a nonce roller outputting a nonce-rolled second midstate values through a modification of the second midstate values by incrementing the nonce by 1 starting from initial nonce,
wherein each of the plurality of first compressors repeatedly performs compression by applying the expansion results from the first expander and the nonce-rolled second midstate values to round functions for each of the multiple unrolled versions.

8. The chip of claim 7, wherein the first stage further comprises:
a second data receiver serially receiving data of the first midstate values for each of the multiple unrolled versions from the version unroller,
wherein the second data receiver restores the received serial data by a 32-bit data word and, adds the restored 32-bit data word to hash computation results of final round function of the plurality of first compressors repeatedly rolled from the initial nonce, thereby generating a third midstate values for each of the multiple unrolled versions.

9. The chip of claim 8, wherein the first stage performs a pre-computation for the first round function by applying a 512-bit third input message and the 256-bit initialization vector to the round functions, and outputs a fourth midstate values,
wherein the 512-bit third input message includes the 256-bit third midstate values repeatedly rolled for each of the multiple unrolled versions and another 256-bit data including a 1-bit indicator representing that the 256-bit third midstate values are the last as message, zero-padded bits, and 32-bit message length.

10. The chip of claim 9, wherein the second stage comprises:
a second expander performing nonce-rolled expansion computations for the third input message for each of the multiple unrolled versions; and
a second compressor performing compression computations by applying the message expanded from the second expander and the initialization vector to the round functions from the 1st round function to the 60th round function.

11. The chip of claim 10, wherein the second stage further comprises:
a result transmitter outputting a final hash computation result by adding the nonce-rolled hash computation result from the round functions of the second compressor for each of the multiple unrolled versions to the initialization vector, a signal indicating the output of the final hash computation result, a signal indicating a result of deciding whether a block has been found through determining whether the final hash computation result is less than or equal to a target value, or a combination thereof.

12. The chip of claim 1, wherein the first stage comprises:
a first expander; and
a plurality of first compressors,
wherein at least one first compressors are placed both above and below the first expander and routed and wired such that the output of the first expander is shared among the at least one first compressors.

13. The chip of claim 1, wherein the first stage and the second stage are horizontally placed for each of the multiple unrolled versions, such that the outputs of the first stage are routed to the inputs of the second stage, thereby minimizing the routed wiring length.

14. The chip of claim 1, wherein at least one second expander and second compressor are placed adjacent to each other in the second stage, either horizontally or vertically, and the routed wiring lengths are minimized by routing outputs of the second expander to inputs of the second compressor.

15. The chip of claim 3, wherein the version unroller is provided in MCU, either inside or outside the chip for multiple hash computations, separately from the cluster, and the first pre-expander and the first pre-compressor are placed adjacent to each other horizontally for each of the multiple unrolled versions, such that the outputs of the first pre-expander are routed to the inputs of the first pre-compressor so as to minimize the routed wiring length.

16. The chip of claim 1, comprises:
250 clusters,
wherein each cluster performs double SHA-256 hash computations on 17 million nonces for at least four different multiple unrolled versions, respectively.
